(19) United States
(12) Patent Application Publication
(10) Pub. No.: US 2007/0047251 A1
(43) Pub. Date: Mar. 1, 2007

(54) Light emitting diode bulb

(76) Inventors: John Sanroma, Billerica, MA (US); Glenn Freeman, Danvers, MA (US); Robert Colburn, Groveland, MA (US); Paul Bitchell, Byfield, MA (US)

Correspondence Address: OSRAM SYLVANIA Inc., 100 Endicott Street, Danvers, MA, 01923, US

(21) Appl. No.: 11/216,294

(22) Filed: Aug. 31, 2005

(51) Int. Cl. F21S 8/10

(52) U.S. Cl. 362/545; 362/294

(57) ABSTRACT

A light emitting diode bulb (10) has a base (12), with a printed circuit board (14) contained therewithin, a plurality of electrical connectors (16) having a first end (18) mounted upon the circuit board (14) and a second end (20) extending away from the base (12) in a direction normal thereto. Each of the electrical connectors (16) comprises at least a first electrically conductive plate (16a), a contiguous insulator (16b) and a second electrically conductive plate (16c). A light emitting diode (22) is electrically connected between the at least a first electrically conductive plate (16a) and the second electrically conductive plate (16c) adjacent the second end (20) on each of the plurality of electrical connectors (16).

### TECHNICAL FIELD

This invention relates to light bulbs and more particularly to solid-state light emitting devices such as light emitting diodes. Still more particularly, it relates light emitting diode bulbs having applicability as light sources for motor vehicle.

### BACKGROUND ART

In the past, most automotive light sources have involved the use of incandescent bulbs. While working well and being inexpensive, these bulbs have a relatively short life and, of course, the thin filament employed was always subject to breakage due to vibration.

Recently some of the uses, particularly the stoplight, have been replaced by LEDs. These solid-state light sources have incredible life times, in the area of 100,000 hours, and are not as subject to vibration failures. However, these LED sources have been hard-wired into their appropriate location, which increases the cost of installation. It would therefore be an advance in the art if an LED light source could be provided that had the ease of installation of the incandescent light sources. It would be a still further advance in the art if an LED light source could be provided that achieved an industry accepted interchangeable standard to replace the aforementioned incandescent bulb.

Such light sources have been developed and occasionally they have employed LEDs in combination with optical fibers or other light guides to concentrate the light of multiple LEDs or to spread the light in a desired fashion. One such light source is described in co-pending patent application Ser. No. 10/899,546, filed Dec. 20, 2004, and assigned to the assignee of the present invention. The latter light source uses a plurality of light guides, in a one-to-one relationship with a like plurality of LEDs. While the arrangement works well, it is expensive and requires a large number of parts, all of which require rather precise alignment. Recently, as disclosed in co-pending patent application Ser. No. 11/058,304, filed Feb. 15, 2005 and assigned to the assignee of the present invention, a light source has been developed using LEDs together with a simplified form of light guide. While this latter approach is also workable it still requires multiple parts and alignment between the LEDs and the light guides. Further, as is the case with all LED light sources, when driven to their maximum potential a good deal of heat sinking is necessary.

Accordingly, it would be an advance in the art if an LED bulb could be provided with a simplified construction. It would be a further advance in the art if the diode supporting structures, electrical connectors and heat sinks could be incorporated into a single unit.

### DISCLOSURE OF INVENTION

It is, therefore, an object of the invention to obviate the disadvantages of the prior art.

It is another object of the invention to enhance LED bulbs.

These objects are accomplished, in one aspect of the invention, by:

A light emitting diode bulb comprising:

a base;

a printed circuit board contained within said base

a plurality of electrical connectors having a first end mounted upon said printed circuit board and a second end extending away from said base in a direction normal thereto, each of said electrical connectors comprising at least a first electrically conductive plate, a contiguous insulator and a second electrically conductive plate; and

a light emitting diode electrically connected between said at least a first and said second electrically conductive plates adjacent said second end on each of said plurality of electrical connectors.

The utilization of the electrical connector as one form of heat sink in addition to functioning as a support for the LEDs greatly simplifies the construction of the bulb.

### BRIEF DESCRIPTION OF THE DRAWINGS

FIG. 1 is a plan view of a light emitting diode bulb employing an embodiment of the invention;

FIG. 2 is an elevational view thereof;

FIG. 3 is an exploded perspective view of an electrical connector according to an embodiment of the invention; and

FIG. 4 is a front elevational view of an electrical connector according to an embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

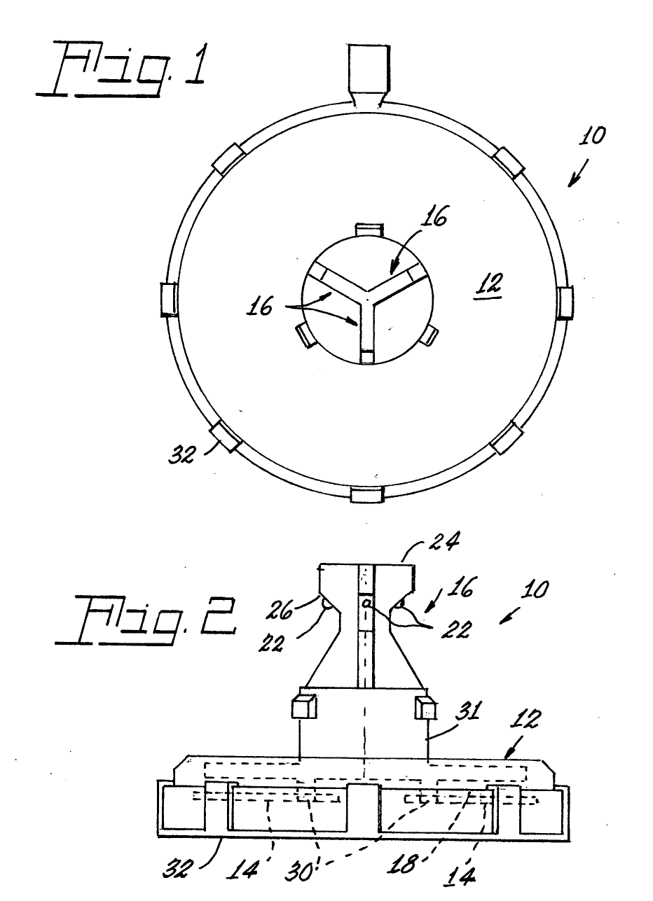

Referring now to the drawings with greater particularity, there is shown in FIGS. 1 and 2 a light emitting diode bulb 10 comprising a base 12, a printed circuit board 14 contained within said base 12, and a plurality of electrical connectors 16 having a first end 18 mounted upon the printed circuit board 14 and a second end 20 extending away from the base 12 in a direction normal thereto, each of the electrical connectors 16 comprising at least a first electrically conductive plate 16a, a contiguous insulator 16b and a second electrically conductive plate 16c. Preferably, the conductive plates are formed from copper having a thickness of 0.8 mm and the contiguous insulator can be a layer of adhesive 0.25 mm thick. Alternatively, other suitable insulator materials or conductive materials can be employed.

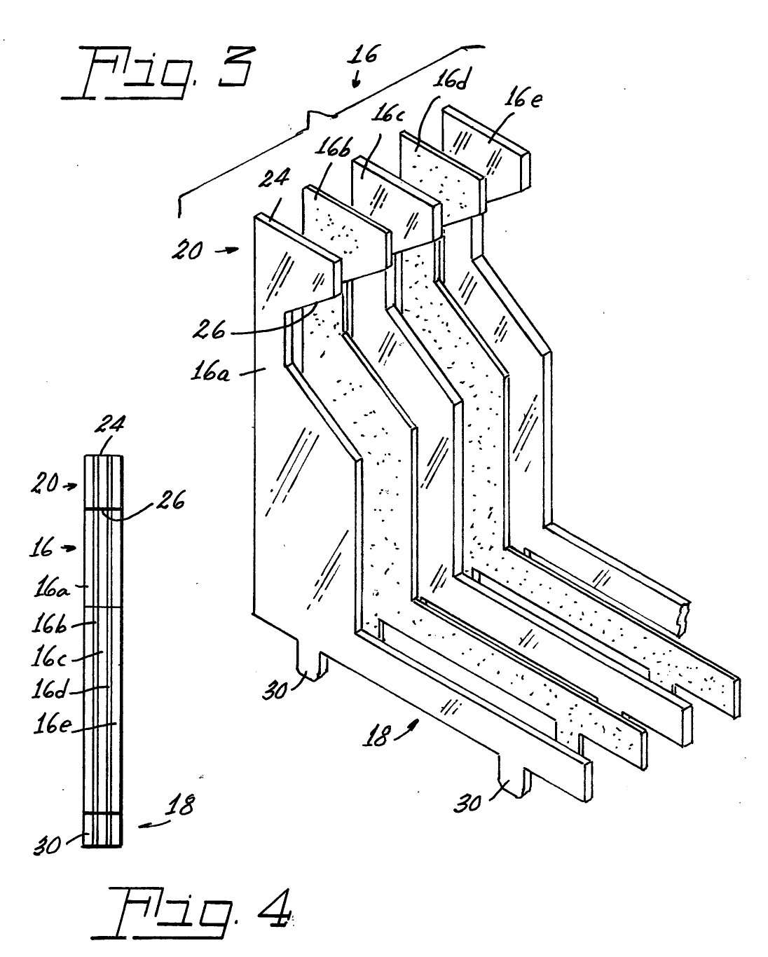

As shown in FIG. 3, the electrical connector 16 includes an additional insulator 16d and a third electrically conductive plate 16e. Such a configuration can be employed for connecting three-lead LEDs such as type Advanced PowerTop (LED), available from Osram Opto, Regensburg, Germany.

When a two-lead LED is used it is only necessary to use two electrically conductive plates 16a and 16c.

A light emitting diode 22 is electrically connected between the conductive plates adjacent the second end 20 on each of the plurality of electrical connectors 16.

In a preferred embodiment of the invention, three electrical connectors 16 are arranged 120 degrees apart, as shown most clearly in FIG. 1.

Preferably, the first end 18 of the connectors 16 is provided with tabs 30 for engagement with the printed circuit board 14 and for electrical connection to the circuitry thereon.

As illustrated, the second ends 20 of the electrical connectors 16 comprise an upper, substantially planar surface 24 and an undercut surface 26, with the light emitting diodes 22 being positioned on the undercut surfaces 26. As thus mounted, the light from the operating LEDs is directed rearwardly, that is, toward the base 12, where, in operation a reflector (not shown) would be positioned. It is then reflected light that is emitted toward the viewing field.

Thus, the electrical connectors 16 provide both the electrical and thermal path for the LEDs as well as positioning the LEDs at an angle for a higher optical efficiency,

The LEDs can be mounted on to the laminated connectors 16 via a reflow process similar to the manner in which surface-mount components are mounted to printed circuit boards. After the LEDs are mounted the driver printed circuit board 14 can be soldered on to the tabs 30 on the first ends 18 of the connectors 16 to form an assembly, which is then overmolded in a suitable plastic, such as Nylon, to provide an electrically insulating layer 31.

After the overmolding process, an additional heat sink 32, such as one shown and described in co-pending patent application Ser. No. 10/838,090, filed May 3, 2004 and assigned to the assignee of the present invention, can be applied.

Many variations are possible in the construction of the LED bulb 10 described above. The electrically conductive plates and the insulators can be stamped in individual pieces and then laminated or the laminations can be first performed, with the completed connectors subsequently stamped. Changing the distance between the LED and the base can regulate the focal length of the bulb. The number and spacing of the electrical connectors can be changed to accommodate different LEDs.

There is thus provided a light emitting diode bulb having a reduced number of parts achieved by combining the electrical and thermal heat sinking functions.

While there have been shown and described what are present considered to be the preferred embodiments of the invention, it will be apparent to those skilled in the art that various changes and modifications can be made herein without departing from the scope of the invention as defined by the appended claims.

1. A light emitting diode bulb comprising:
a base;
a printed circuit board contained within said base;
a plurality of electrical connectors having a first end mounted upon said printed circuit board and a second end extending away from said base in a direction normal thereto, each of said electrical connectors comprising at least a first electrically conductive plate having a given planar configuration, a contiguous insulator having a planar configuration identical to said given configuration and a second electrically conductive plate having a planar configuration identical to said given configuration; and
a light emitting diode electrically connected between said at least a first and said second electrically conductive plates adjacent said second end on each of said plurality of electrical connectors.

2. The light emitting diode bulb of claim 1 wherein each of said electrical connectors comprises a second contiguous insulator having a planar configuration identical to said given configuration and a third electrically conductive plate having a planar configuration identical to said given configuration.

3. The light emitting diode bulb of claim 2 wherein said plurality of electrical connectors comprises only three such connectors arranged 120 degrees apart.

4. The light emitting diode bulb of claim 3 wherein said second ends of said electrical connectors comprise an upper, substantially planar surface and an undercut surface having a plane substantially directed toward said base and said light emitting diodes are positioned on said undercut surfaces, light emitted from said light emitting diodes being directed toward said base.
